(19) United States
(12) Patent Application Publication
(10) Pub. No.: US 2011/0187189 A1
(43) Pub. Date: Aug. 4, 2011

(54) SYSTEM AND METHOD FOR CONTROLLING SINGLE INDUCTOR DUAL OUTPUT DC/DC CONVERTERS

(75) Inventors: ZAKI MOUSSAOUI, SAN CARLOS, CA (US); JIFENG QIN, SAN JOSE, CA (US)

(73) Assignee: INTERSIL AMERICAS INC., MILPITAS, CA (US)

(21) Appl. No.: 12/796,334

(22) Filed: Jun. 8, 2010

Related U.S. Application Data
(60) Provisional application No. 61/300,579, filed on Feb. 2, 2010.

(51) Int. Cl. G05F 1/10

(52) U.S. Cl. 307/31

(57) ABSTRACT

A DC to DC converter comprises voltage regulation circuitry for generating at least two output voltages responsive to an input voltage. The voltage regulation circuitry further includes a plurality of main switches connected to receive the input voltage. A plurality of auxiliary switches is connected to provide the at least two output voltages. A single inductor is connected between the plurality of main switches and the plurality of auxiliary switches. A dual-output PWM controller provides a first PWM control signal for controlling the operation of the plurality of main switches responsive to a first feedback voltage from a first output voltage using a first control loop and provides a second PWM control signal for controlling the operation of the plurality of auxiliary switches responsive to a second feedback voltage from a second output voltage using a second control loop. Current mode control can be used for each control loop to reduce the cross regulation problem.

### CROSS-REFERENCE TO RELATED APPLICATIONS

This application claims priority from U.S. Provisional Application No. 61/300,579, filed Feb. 2, 2010, entitled CONTROL SCHEME FOR SINGLE INDUCTOR DUAL OUTPUT DC/DC CONVERTER, which is incorporated herein by reference.

### BRIEF DESCRIPTION OF THE DRAWINGS

For a more complete understanding, reference is now made to the following description taken in conjunction with the accompanying Drawings in which:

FIG. 1 is a schematic diagram of a DC/DC converter for use with high current space-limited applications;

FIG. 2 is a table illustrating the system efficiency data for up to a 5 amp load at each rail for the DC/DC converter of FIG. 1;

FIG. 3 is a schematic diagram of a DC/DC converter for use with a high input voltage variation system such as a solar application;

FIG. 4 is a table illustrating the system efficiencies for the DC/DC converter of FIG. 3;

FIG. 5 illustrates a schematic diagram of a first control scheme for controlling the operation of the DC/DC converters of FIGS. 1 and 3;

FIG. 6 is a flow diagram describing the operation of the control scheme of FIG. 5;

FIG. 7 illustrates a second control scheme for controlling the DC/DC converters of FIGS. 1 and 3; and

FIG. 8 is a flow diagram describing the operation of the control scheme of the DC/DC converter of FIG. 7.

### DETAILED DESCRIPTION

Referring now to the drawings, wherein like reference numbers are used herein to designate like elements throughout, the various views and embodiments of a system and method for controlling single inductor dual output DC/DC converters are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

Single inductor, dual output DC/DC converters enable the use of a single inductor to obtain dual regulated output voltages. This provides a DC/DC converter of high efficiency, lower cost and smaller size than converters utilizing dual inductors. Normally, the inductor size of the DC/DC converter can be quite large. By only using a single inductor within a DC/DC converter to generate two output voltage rails, the total size of the DC/DC converter can be greatly reduced enabling the circuitry to be implemented within a single power module. In one embodiment, a system using a total of 10 amps of load current (5 amps at each output), provides a structure that is stable and can achieve an overall efficiency of 93.5% peak. A single inductor dual output converter can also be utilized in systems which require large input voltage variation, such as solar applications. Solar applications are different from space-limited applications in that within a solar system, several DC/DC buck converters are required to provide the system bias from a high variant DC voltage taken from the output of the solar panel. If only a single inductor is used to handle the job, the total size and cost of the system will be greatly reduced. In a solar application embodiment using an 80 volt input voltage and up to 50 milliamp load current, the overall efficiency is superior to the conventional linear regulation scheme.

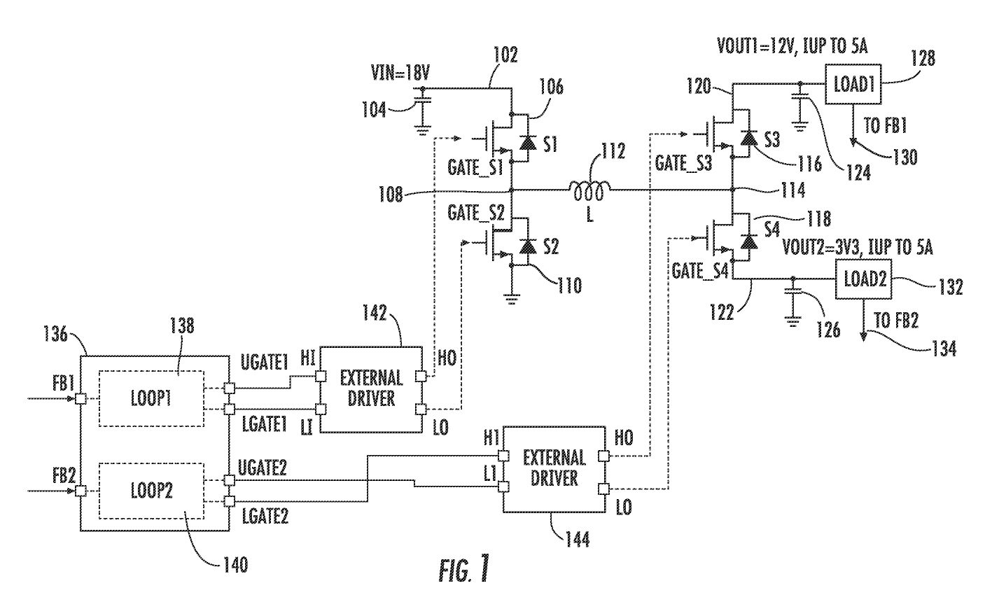

Referring now to FIG. 1, there is illustrated the implementation of a control system within a high current space-limited application. The input voltage V_{IN} of 18 volts is applied at an input voltage node 102. A capacitor 104 is connected between node 102 and ground. Main switches consisting of a first switching transistor 106 and a second switching transistor 110 are connected between node 102 and ground. Transistor 106 is a N-channel transistor having its drain/source path connected between node 102 and the phase node 108. A second switching transistor 110 comprises a N-channel transistor having its drain/source path connected between node 108 and ground. An inductor 112 is connected between node 108 and node 114.

The auxiliary switching transistor 116 and 118 are connected between a first output voltage node 120 and a second output voltage node 122. The first auxiliary switching transistor 116 has its drain/source path connected between node 120 and node 114. The second auxiliary switching transistor 118 has its drain/source path connected between node 114 and node 122. Each of the auxiliary switching transistors 116 and 118 comprise N-channel transistors. A capacitor 124 is connected between the first output voltage node 120 and ground. A second capacitor 126 is connected between the second output voltage node 122 and ground. A first load 128 is connected to the first output voltage load 120 and the first feedback signal FB1 is generated at 130. A second load 132 is connected to the second output voltage node 122 and a second feedback FB2 is generated at 134. Each of the FB1 feedback signal 130 provided from load 128 and the FB2 feedback signal 134 provided from load 132 are provided to a dual-output PWM controller 136. In one embodiment, the dual-output PWM controller 136 may comprise the Intersil ISL8120 controller provided by Intersil Americas Inc.

The dual-channel output PWM controller 136 includes a first control loop 138 and a second control loop 140. The first control loop 138 is used for generating the PWM control signals to the external driver 142 associated with the primary DC/DC converter switches 106 and 110. A second control loop 140 generates PWM signals responsive to the FB2 control signal 134. The second control loop 140 drives external driver 144 which drives the auxiliary switches 116 and 118. Responsive to the 18 volt input voltage V_{IN}, a voltage of the output node V_{OUT1} may equal 12 volts with a current of up to 5 amps and the output voltage at node 122 may equal 3.3V volts with up to 5 amps of current. The V_{OUT2} voltage from node 120 is provided to the first control loop 138 to control the duty cycle of main switches 106 and 110. The V_{OUT2} voltage is sensed and provided to the second control loop 140 to control the duty cycle of auxiliary switches 116 and 122. The phase shift of the two PWM signals generated within control loop 138 and control loop 140 is zero degrees, thus the switches 106 and 118 are turned off at the same time.

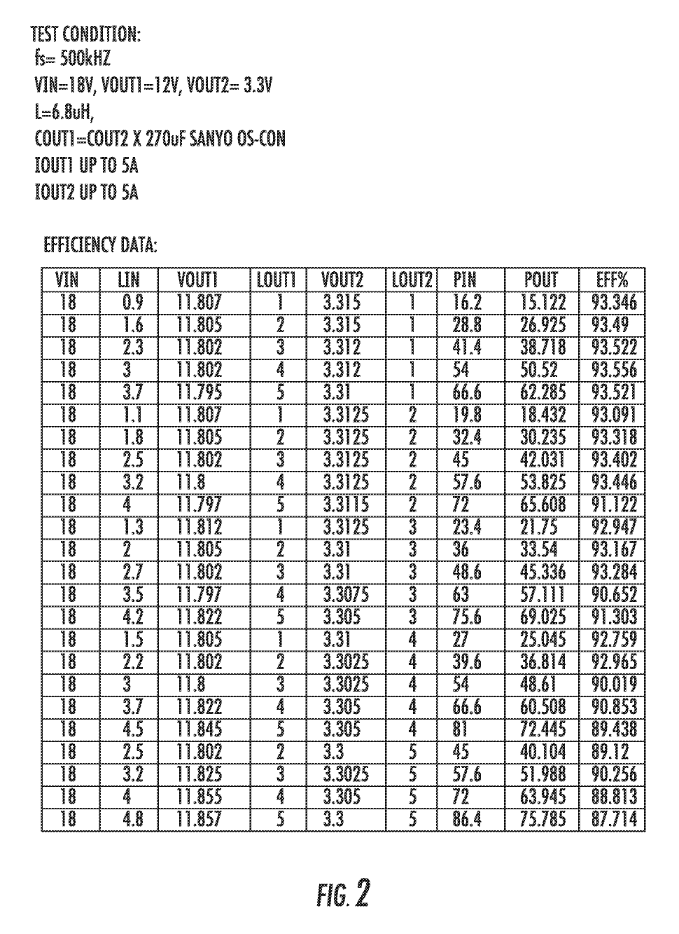

Referring now to FIG. 2, there are illustrated the system efficiencies of the circuit of FIG. 1 for up to a 5 amps load at each output voltage rail 120 and 122. The overall system efficiency is up to 10 amps (5 amps per output). The peak efficiency is about 93.5% and the DC/DC converter maintains good efficiency over the entire load range. The switching frequency of the DC/DC converter is close to 500 kHz.

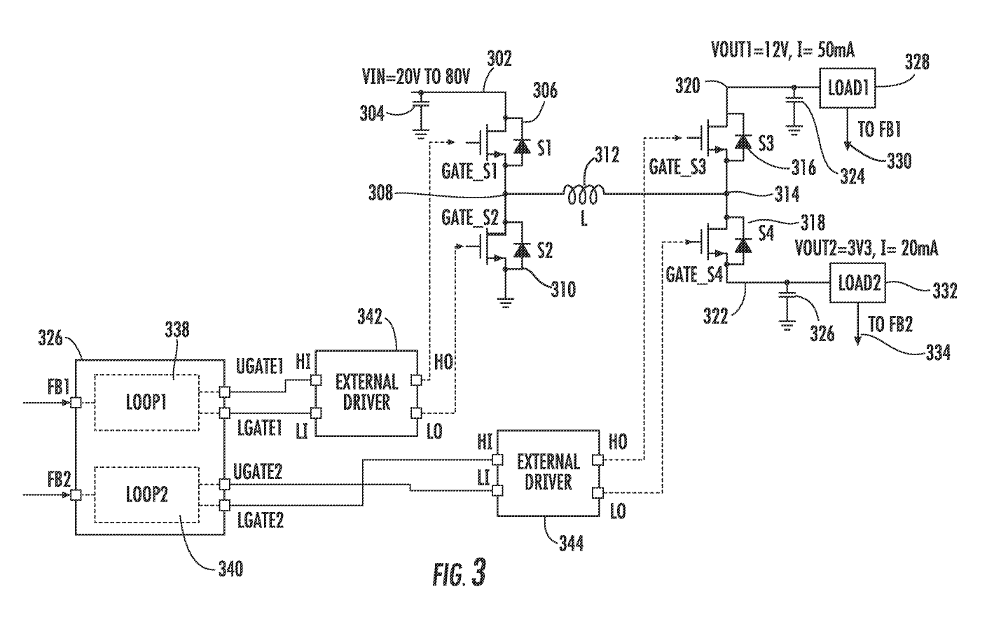

Referring now to FIG. 3, there is illustrated the system schematic for a high voltage, low current system with high input voltage variation. The input voltage V_{IN} from 20V to 80 V is applied at an input voltage node 302. A capacitor 304 is connected between node 302 and ground. Main switches consisting of a first switching transistor 306 and a second switching transistor 310 are connected between node 302 and ground. Transistor 306 is a N-channel transistor having its drain/source path connected between node 302 and the phase node 308. A second switching transistor 310 comprises a N-channel transistor having its drain/source path connected between node 308 and ground. An inductor 312 is connected between node 308 and node 314.

The auxiliary switching transistor 316 and 318 are connected between a first output voltage node 320 and a second output voltage node 322. The first auxiliary switching transistor 316 has its drain/source path connected between node 320 and node 314. The second auxiliary switching transistor 318 has its drain/source path connected between node 314 and node 322. Each of the auxiliary switching transistors 316 and 318 comprise N-channel transistors. A capacitor 324 is connected between the first output voltage node 320 and ground. A second capacitor 326 is connected between the second output voltage node 322 and ground. A first load 328 is connected to the first output voltage load 320 and the first feedback signal FB1 is generated at 330. A second load 332 is connected to the second output voltage node 322 and a second feedback FB2 is generated at 334. Each of the FB1 feedback signal 330 provided from load 328 and the FB2 feedback signal 334 provided from load 332 are provided to a dual-output PWM controller 336. In one embodiment, the dual-output PWM controller 336 may comprise the Intersil ISL8120 controller provided by Intersil Americas Inc.

The dual-channel output PWM controller 336 includes a first control loop 338 and a second control loop 340. The first control loop 338 is used for generating the PWM control signals to the external driver 342 associated with the primary DC/DC converter switches 306 and 310. A second control loop 340 generates PWM signals responsive to the FB2 control signal 334. The second control loop 340 drives external driver 344 which drives the auxiliary switches 316 and 318.

As can be seen, the configuration of the circuit of FIG. 3 is similar to that described previously with respect to the high current, space-limited implementation of FIG. 1. Within the high input voltage variation application, the input voltage V_{IN} at node 302 may range from 20 volts to 80 volts. The output voltage V_{OUT1} at node 320 of 12 volts is sensed and fed into the first current control loop 338 to control the duty cycle of the main switches 306 and 310. The output voltage V_{OUT2} at node 322 of approximately 3.3 volts is sensed and fed into the second control loop 340 that controls the duty cycle of auxiliary switches 320 and 318.

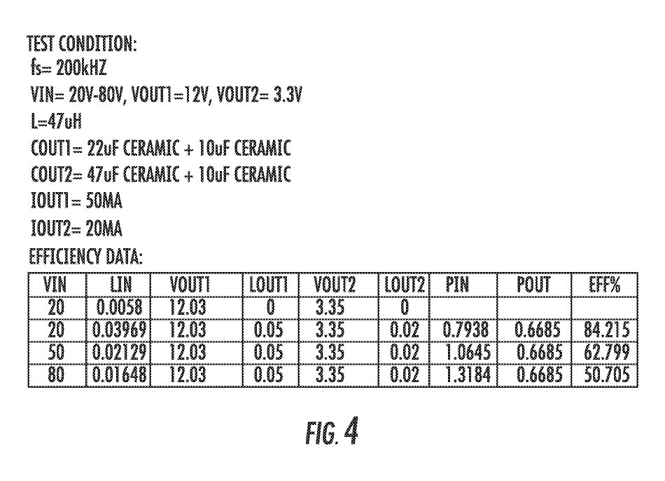

FIG. 4 comprises a table illustrating the tested overall system efficiency for an output current I_{OUT1} of 50 milliamps, an I_{OUT2} current of 20 milliamps or different input voltages V_{IN}. Within the implementation of FIG. 3, the input voltage V_{IN} may range from 20 volts to 80 volts. The first output voltage V_{OUT1} will be approximately 12 volts with an output current of 50 milliamps. The second output voltage V_{OUT2} is approximately 3 volts with an output current of 20 milliamps.

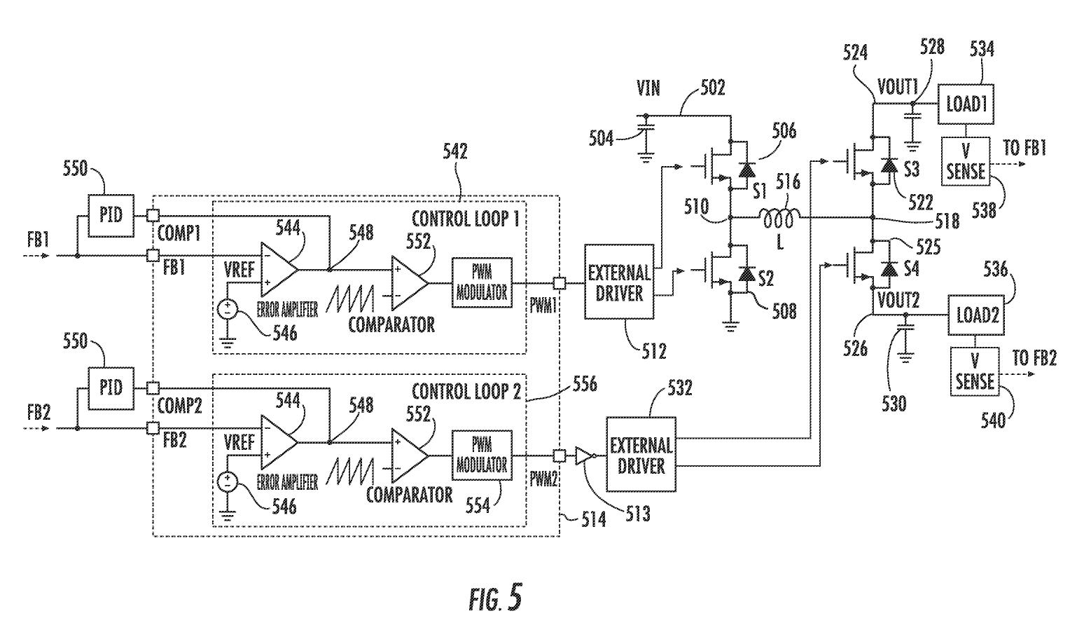

Referring now to FIG. 5, there is illustrated further detail with respect to the control loops of the dual-output PWM controller. As described previously, the dual-output DC/DC converter includes an input voltage node 502 to which the input voltage V_{IN} is applied. A capacitor 504 is connected between the input voltage node 502 and ground. The main switching transistors consist of a transistor 506 and 508 connected between node 502 and ground. The transistor 506 comprises a N-channel transistor having its drain/source path connected between node 502 and node 510. Transistor 508 comprises a N-channel transistor having its drain/source path connected between node 510 and ground. The gates of transistors 506 and 508 receive drive signals from an external driver 512 that is responsive to PWM control signals from the dual-channel PWM controller 514.

An inductor 516 is connected between node 510 and node 518. A pair of secondary switches 520 and 522 are connected between the first output voltage node V_{OUT1} 524 and a second output voltage node V_{OUT2} 526. Transistor 522 comprises a N-channel transistor having its drain/source path connected between node 524 and node 518. Transistor 525 comprises a N-channel transistor having its drain/source path connected between node 524 and node 518. Transistor 525 comprises a N-channel transistor having its drain/source path connected between node 518 and node 526. A capacitor 528 is connected between node 524 and ground. A capacitor 530 is connected between node 526 and ground. The gates of transistors 522 and 525 are connected to receive driver signals from external drivers 512 and 532 that generate driver signals responsive to a PWM control signal provided from the dual-output PWM controller 514. First and second loads 534 and 536 are connected to output voltage nodes V_{OUT1} 524 and V_{OUT2} 526, respectively.

The voltage sensing circuitry 538 monitors the output voltage from node 524 to generate the FB2 control signal. A voltage sensing circuitry 540 monitors the output voltage at node 526 to generate a second voltage feedback signal FB1. The dual-channel PWM controller 514 receives the feedback control signals FB1 and FB2 from each of the voltage sensing circuitries 538 and 540. The FB1 signal is provided to a first control loop 542. The first control loop 542 consists of an error amplifier 544 having its inverting input connected to the FB1 input pin and its non-inverting input connected to receive a reference voltage V_{REF} from a voltage source 546. The error amplifier 544 compares the feedback voltage with the reference voltage to generate an error voltage signal (COMP) at node 548. The output of the error amplifier 544 is provided at the output COMP1 pin which is provided to an associated proportional integral differential (PID) compensation network 550. The PID network 550 is in a feedback loop with the error amplifier 544 to provide loop compensation to the input FB1 pin.

The output of the error amplifier 544 is also connected with the non-inverting input of a comparator 552. The comparator 552 compares the COMP signal from the error amplifier 544 with a slope compensation ramp signal provided to the inverting input of comparator 552. The comparator 552 determines the duty cycle of the PWM1 output signal and provides a control output to the PWM modulator 554 when the COMP signal exceeds the ramp signal at the input of the comparator 552. The PWM modulator 554 generates the PWM control signals to an inverter 713 having its output connected to the external driver 512 such that the external driver 512 can drive the main switches 506 and 508. As a result, the gate drive signals provided by the external driver 512 will be complementary for switches 506 and 508. The negative feedback loop ensures the voltage regulation of the V_{OUT1} node 524. When the V_{OUT1} voltage increases, the feedback loop will force a shorter turn on time of switch 506. This will cause less energy to be transferred through the inductor 516 and the output voltage V_{OUT1} at node 524 will be brought down to the steady state value.

The second control loop 556 is used for controlling the turn on and turn off times of the auxiliary switches consisting of transistors 522 and 525. The second control loop 556 operates in the same manner as that described with respect to the control loop 542. The elements within the control loop 556 operate in a similar manner and similar reference numerals are used accordingly. As the control loops operate in a similar manner, the gate drive signals of transistors 522 and 524 will also be complementary. When the V_{OUT2} rail voltage at node 526 is increased, the negative feedback control loop will force a shorter turn on time of switch 525 and more turn on time for switch 522. This will cause less energy to be transferred to the V_{OUT2} rail at node 526 and the voltage will be brought down to the steady state value. Since the PWM phase shift of both channels is zero degrees, the turn off signal of main switch 506 and auxiliary switch 524 are synchronized.

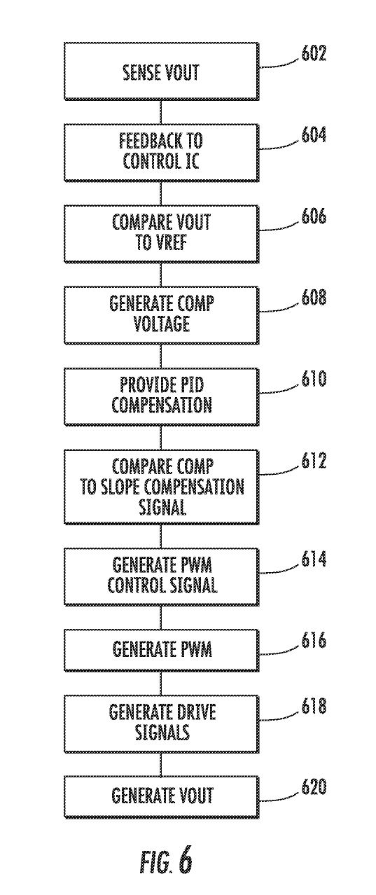

Referring now to FIG. 6, there is illustrated a flow diagram describing the operation of the control loop of the multi-channel PWM controller. Initially, the output voltage V_{OUT} is sensed at step 602. The sensed output voltage is provided at step 604 as feedback to the control IC. Within the error amplifier 544 of the control loop, the output voltage V_{OUT} is compared at step 606 with the reference voltage V_{REF}. This is used to generate at step 608 the error voltage/COMP signal. The COMP signal is provided to the PID compensation network at step 610 to provide feedback compensation within the error amplifier 544. The COMP signal is also compared at step 612 with the slope compensation ramp signal by the comparator 552. The results of this comparison are used to generate a PWM control signal at step 614 that is provided to the PWM modulator 554. The PWM modulator 554 generates the PWM control signals at step 616 which are used by the external driver circuitry to generate drive signals at step 618. The switching of the drive signals provided to the various switching transistors are used to generate the associated output voltages at step 620. Each of the control loops operate in a similar manner for each of the output voltage rails.

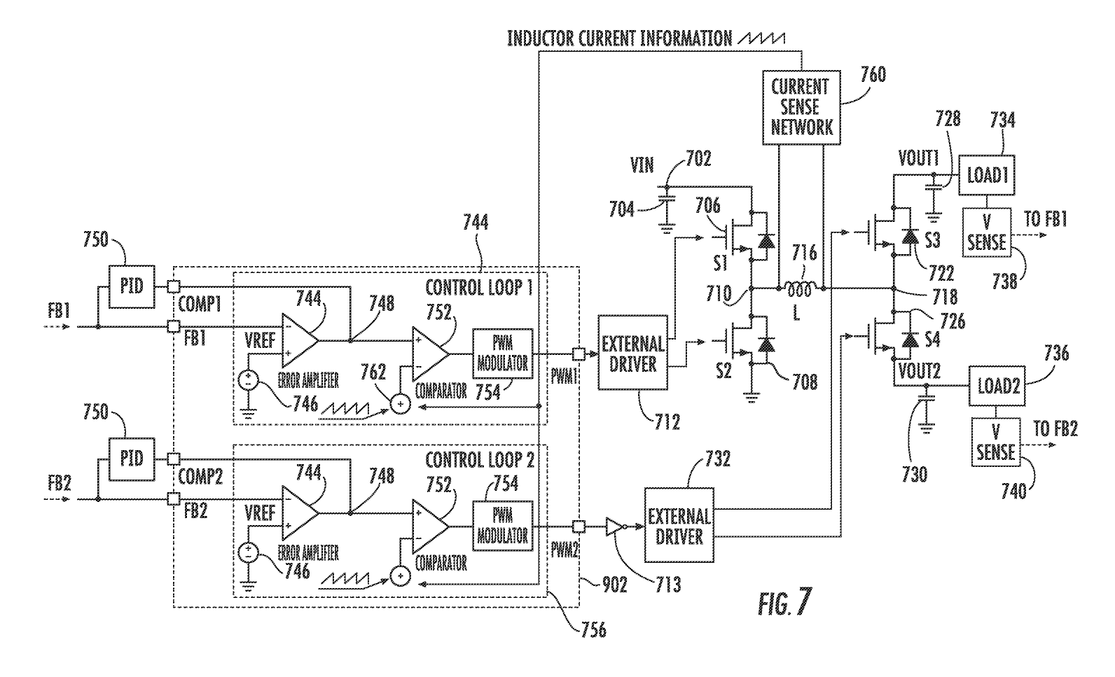

Referring now to FIG. 7, there is illustrated an alternative current mode control method for use within the control loops of the multi-channel PWM controller. As described previously, the dual-output DC/DC converter includes an input voltage node 702 to which the input voltage V_{IN} is applied. A capacitor 704 is connected between the input voltage node 702 and ground. The main switching transistors consist of a transistor 706 and 708 connected between node 702 and ground. The transistor 706 comprises a N-channel transistor having its drain/source path connected between node 702 and node 710. Transistor 708 comprises a N-channel transistor having its drain/source path connected between node 710 and ground. The gates of transistors 706 and 708 receive drive signals from an external driver 712 that is responsive to PWM control signals from the dual-channel PWM controller 714.

An inductor 716 is connected between node 710 and node 718. A pair of secondary switches 720 and 722 are connected between the first output voltage node V_{OUT1} 724 and a second output voltage node V_{OUT2} 726. Transistor 722 comprises a N-channel transistor having its drain/source path connected between node 724 and node 718. Transistor 725 comprises a N-channel transistor having its drain/source path connected between node 724 and node 718. Transistor 725 comprises a N-channel transistor having its drain/source path connected between node 718 and node 726. A capacitor 728 is connected between node 724 and ground. A capacitor 730 is connected between node 726 and ground. The gates of transistors 722 and 725 are connected to receive driver signals from external drivers 712 and 732 that generate driver signals responsive to a PWM control signal provided from the dual-output PWM controller 714. A first and second load 734 and 736 connected to output voltage nodes V_{OUT1} 724 and V_{OUT2} 726, respectively.

The voltage sensing circuitry 738 monitors the output voltage from node 724 to generate the FB2 control signal. A voltage sensing circuitry 740 monitors the output voltage at node 726 to generate a second voltage feedback signal FB1. The multi-channel PWM controller 714 receives the feedback control signals FB and FB2 from each of the voltage sensing circuitries 738 and 740. The FB1 signal is provided to a first control loop 742. The first control loop 742 consists of an error amplifier 744 having its inverting input connected to the FB1 input pin and its non-inverting input connected to receive a reference voltage V_{REF} from a voltage source 746. The error amplifier 744 compares the feedback voltage with the reference voltage to generate an error voltage signal (COMP) at node 748. The output of the error amplifier 744 is provided at the output COMP1 pin which is provided to an associated proportional integral differential (PID) compensation network 750. The PID network 750 is in a feedback loop with the error amplifier 744 to provide loop compensation to the input FB1 pin.

The output of the error amplifier 744 is also connected with the non-inverting input of a comparator 752. The comparator 752 compares the COMP signal from the error amplifier 744 with a modified slope compensation ramp signal provided to the inverting input of comparator 752. The difference between the method described in FIG. 5 and the current mode control method described in FIG. 7 is that there is an additional inductor current sensing network 760 that senses the inductor current waveform through inductor 716 directly. The sensed inductor waveform is added with the internal slope compensation ramp signal at adder 762. The comparator 752 determines the duty cycle of the PWM1 output signal and provides a control output to the PWM modulator 754 when the COMP signal exceeds the ramp signal at the input of the comparator 752. The PWM modulator 754 generates the PWM control signals to an inverter 713 having its output connected to the external driver 712 such that the external driver 712 can drive the main switches 506 and 508. As a result, the gate drive signals provided by the external driver 712 will be complementary for switches 506 and 508. The negative feedback loop ensures the voltage regulation of the V_{OUT1} node 724. When the V_{OUT1} voltage increases, the feedback loop will force a shorter turn on time of switch 506. This will cause less energy to be transferred through the inductor 716 and the output voltage V_{OUT1} at node 724 will be brought down to the steady state value.

The second control loop 756 is used for controlling the turn on and turn off times of the auxiliary switches consisting of transistors 722 and 726. The second control loop 756 operates in the same manner as that described with respect to the control loop 742. The elements within the control loop 756 operate in a similar manner and similar reference numerals are used accordingly. As the control loops operate in a similar manner, the gate drive signals of transistors 722 and 726 will also be complementary. When the V_{OUT2} rail voltage at node 726 is increased, the negative feedback control loop will force a shorter turn on time of switch 726 and more turn on time for switch 722. This will cause less energy to be transferred to the V_{OUT2} rail at node 726 and the voltage will be brought down to the steady state value. Since the PWM phase shift of both channels is zero degrees, the turn off signal of main switch 506 and auxiliary switch 724 are synchronized.

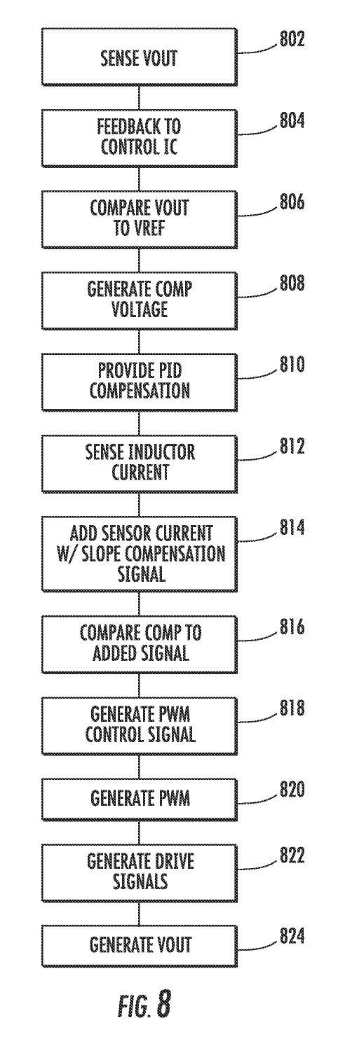

Referring now to FIG. 8, there is illustrated a flow diagram describing the operation of the control loop for each channel of the DC/DC converter. By using current mode control, the effects of first channel output current change to the second channel output change will be reduce, therefore cross regulation problem can be minimized. The output voltage V_{OUT} is sensed at step 802 and provided as feedback to the control IC at step 804. The feedback control loop 742 or 756 compares the output voltage at step 806 with the reference voltage V_{REF}. This is used for the error amplifier 744 to generate the comparator voltage at step 808. Responsive to the comparator voltage a PID compensation loop is provided at step 810 through the PID network 550. Additionally, the inductor current through the inductor 516 is sensed by the current sense network 760 at step 812. The sensed current is added at step 814 with the slope compensation signal ramp at adder 762. The added signal is compared at comparator 752 with the COMP signal at step 816. The output of the comparator 752 is used to generate at step 818 a PWM control signal which is provided to the PWM modulator 754 to generate at step 820 the PWM signal. The generated PWM signals are used to generate the drive signals via the external drivers at step 822, and the auxiliary and main switches may then generate the various output voltages at step 824 responsive to the drive signals.

Using the above described system, a simple control scheme for controlling a single inductor dual-output DC/DC converter is provided. The system demonstrates both high current and high voltage capabilities while reducing the size and cost of the circuitry over a two inductor solution as only a single inductor is necessary. The system provides for good overall efficiency and may utilize a PWM controller including only simple logic circuitry. The single inductor dual output converter structure described herein can be used in space limited applications such as power module applications where system integration is required. The structure would be especially useful for low current applications where the size of the single inductor will be smaller than two inductors providing the same peak current at the same steady state condition for Vin, Vout, switching frequency, etc. Another benefit of the described single inductor dual output converter structure is that the auxiliary output (Vout2 in FIG. 5) is immune to input line voltage changes because the output is only fed by a current source. Also by using the current mode control scheme illustrated in FIG. 7, the cross regulation issue (the Vout2 variation because of load 1 current variation) can be reduced.

It will be appreciated by those skilled in the art having the benefit of this disclosure that this system and method for controlling single inductor dual output DC/DC converters provides improved control of single inductor converters. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A DC to DC converter, comprising:
voltage regulation circuitry for generating at least two output voltages responsive to an input voltage, wherein the voltage regulation circuitry further comprises:
a plurality of main switches connected to receive the input voltage;
a plurality of auxiliary switches connected to provide the at least two output voltages;
a single inductor connected between the plurality of main switches and the plurality of auxiliary switches;
a dual-output PWM controller for providing a first PWM control signal for controlling the operation of the plurality of main switches responsive to a first feedback voltage from a first output voltage using a first control loop and for providing a second PWM control signal for controlling the operation of the plurality of auxiliary switches responsive to a second feedback voltage from a second output voltage using a second control loop.

2. The DC to DC converter of claim 1, further comprising:
a first driver circuit for driving the plurality of main switches responsive to the first PWM signal; and
a second driver circuit for driving the plurality of auxiliary switches responsive to the second PWM signal.

3. The DC to DC converter of claim 2, wherein first and second control signals for driving the plurality of main switches are complementary and further wherein first and second control signals for driving the plurality of auxiliary switches are complementary.

4. The DC to DC converter of claim 2, wherein the first control loop further comprises:
a first error amplifier for comparing the first feedback voltage with a reference voltage and generating a first error voltage signal responsive thereto;
a first comparator for comparing the first error voltage signal with a slope compensation signal and generating a first PWM control signal responsive thereto; and
a first PWM modulator for generating the first PWM signal for driving the plurality of main switches responsive to the first PWM control signal.

5. The DC to DC converter of claim 4, wherein the second control loop further comprise:
a second error amplifier for comparing the second feedback voltage with the reference voltage and generating a second error voltage signal responsive thereto;
a second comparator for comparing the second error voltage signal with the slope compensation signal and generating a second PWM control signal responsive thereto; and
a second PWM modulator for generating the second PWM signal for driving the plurality of auxiliary switches responsive to the second PWM control signal.

6. The DC to DC converter of claim 5, further including:
a first proportional-integral-differential compensation network connected in a first feedback loop between an output of the first error amplifier and a first feedback input of the first error amplifier; and
a second proportional-integral-differential compensation network connected in a second feedback loop between an output of the second error amplifier and a first feedback input of the second error amplifier.

7. The DC to DC converter of claim 5, further including:
a current sense network for monitoring a current through the inductor and generate a sensed inductor current waveform; and
at least one adder circuit for generating the slope compensation signal by adding the sensed inductor current waveform with a ramp signal.

8. A dual-output PWM controller for a single inductor dual output DC to DC converter, comprising:
a plurality of feedback inputs, each from an output of a network for monitoring an output voltage of the dual-output, single inductor DC to DC converter;
a first control loop for providing a first PWM signal for controlling the operation of a plurality of main switches of the DC to DC converter responsive to a first feedback voltage from a first feedback input;
a second control loop for providing a second PWM signal for controlling the operation of a plurality of auxiliary switches of the DC to DC converter responsive to a second feedback voltage from a second feedback input;
an output associated with each of the first and the second control loops providing the first and the second PWM signals.

9. The dual-output PWM controller of claim 8, wherein the first and the second PWM signals enable generation of first and second control signals for driving the first and the second main switches are complementary and further wherein first and second control signals for driving the first and the second auxiliary switches are complementary.

10. The dual-output PWM controller of claim 8, wherein the first control loop further comprises:
a first error amplifier for comparing the first feedback voltage with a reference voltage and generating a first error voltage signal responsive thereto;
a first comparator for comparing the first error voltage signal with a compensation signal and generating a first PWM control signal responsive thereto; and
a first PWM modulator for generating the first PWM signal for driving the first and the second main switches responsive to the first PWM control signal.

11. The dual-output PWM controller of claim 10, wherein the second control loop further comprise:
a second error amplifier for comparing the second feedback voltage with the reference voltage and generating a second error voltage signal responsive thereto;
a second comparator for comparing the second error voltage signal with the compensation signal and generating a second PWM control signal responsive thereto; and
a second PWM modulator for generating the second PWM signal for driving the first and the second auxiliary switches responsive to the second PWM control signal.

12. The dual-output PWM controller of claim 11, further including:
a first proportional-integral-differential compensation network connected in a first feedback loop between an output of the first error amplifier and a first feedback input of the first error amplifier; and
a second proportional-integral-differential compensation network connected in a second feedback loop between an output of the second error amplifier and a first feedback input of the second error amplifier.

13. The dual-output PWM controller of claim 11 further including:
a first adder circuit, within the first control loop, for generating a first slope compensation signal by adding a sensed inductor current waveform associated with an inductor of the DC to DC converter with a ramp signal; and
a second adder circuit, within the second control loop, for generating a second slope compensation signal by adding the sensed inductor current waveform associated with an inductor of the DC to DC converter with the ramp signal.

14. A method for providing DC to DC voltage regulation within a dual output, single inductor DC to DC voltage regulator, comprising the steps of:
receiving an input voltage;
monitoring a feedback voltage from a plurality of outputs of the voltage regulator;
providing a first PWM signal for controlling the operation of a plurality of main switches of the voltage regulator responsive to a first feedback voltage from a first output using a first control loop;
providing a second PWM signal for controlling the operation of a plurality of auxiliary switches responsive to a second feedback voltage from a second output using a second control loop;
switching the plurality of main switches responsive to the first PWM signal;
switching the plurality of auxiliary switches responsive to the second PWM signal; and
generating at least two output voltages responsive to the input voltage and the switching of the main switches and the auxiliary switches.

15. The method of claim 14, further comprising the steps of:
driving the plurality of main switches responsive to the first PWM signal; and
driving the plurality of auxiliary switches responsive to the second PWM signal.

16. The method of claim 14, wherein the step of providing the first PWM signal further comprises the steps of:
comparing a first feedback voltage with a reference voltage;
generating a first error voltage signal responsive to the comparison of the first feedback voltage and the reference voltage;
comparing the first error voltage signal with a slope compensation signal;
generating a first PWM control signal responsive the comparison of the first error voltage signal and the slope compensation signal; and
generating the first PWM signal for driving the plurality of main switches responsive to the first PWM control signal.

17. The method of claim 16, wherein the step of providing the second PWM signal further comprises the steps of:
comparing a second feedback voltage with the reference voltage;
generating a second error voltage signal responsive to the comparison of the second feedback voltage and the reference voltage;
comparing the second error voltage signal with the slope compensation signal;
generating a second PWM control signal responsive the comparison of the second error voltage signal and the slope compensation signal; and
generating the second PWM signal for driving the plurality of main switches responsive to the second PWM control signal.

18. The method of claim 17, further including the steps of:
providing a first proportional-integral-differential compensation network connected in a first feedback loop between an output of the first error amplifier and a first feedback input of the first error amplifier;
providing a second proportional-integral-differential compensation network connected in a second feedback loop between an output of the second error amplifier and a first feedback input of the second error amplifier;
altering the first feedback voltage responsive to the first proportional-integral-differential compensation network; and
altering the second feedback voltage responsive to the second proportional-integral-differential compensation network.

19. The method of claim 18, further including steps of:
monitoring a current through an inductor of the voltage regulator;
generating a sensed inductor current waveform for the inductor of the voltage regulator; and
generating the slope compensation signal by adding the sensed inductor current waveform with a ramp signal.

20. A solar system comprising:
at least one solar panel;
a DC to DC converter connected to an output of each of the at least one solar panels, the DC to DC converter comprising:
voltage regulation circuitry for generating at least two output voltages responsive to an input voltage, wherein the voltage regulation circuitry further comprises:
a plurality of main switches connected to receive the input voltage;
a plurality of auxiliary switches connected to provide the at least two output voltages;
a single inductor connected between the plurality of main switches and the plurality of auxiliary switches;
a dual-output PWM controller for providing a first PWM control signal for controlling the operation of the plurality of main switches responsive to a first feedback voltage from a first output voltage using a first control loop and for providing a second PWM control signal for controlling the operation of the plurality of auxiliary switches responsive to a second feedback voltage from a second output voltage using a second control loop.
